(19) United States
(12) Patent Application Publication
(10) Pub. No.: US 2007/0088719 A1
(43) Pub. Date: Apr. 19, 2007

(54) System and method for storing multi-dimensional network and security event data

(76) Inventors: Stuart Staniford, San Francisco, CA (US); Paul Howard Sobel, Santa Clara, CA (US)

Correspondence Address: PATRICK REILLY, P.O BOX 7218, SANTA CRUZ, CA, 95061-7218, US

(21) Appl. No.: 11/250,301

(22) Filed: Oct. 14, 2005

(51) Int. Cl. G06F 7/00

(52) U.S. Cl. 707/100

(57) ABSTRACT

A system and method are provided for associating and storing data in contiguous memory locations of a secondary memory to enable efficient searching of the archived data. Current events are organized in a main memory within a data structure, e.g., an R-tree, chosen to increase the likelihood that data clustered together are more likely to relate to a same query. Most recent data is temporarily stored in the main memory to ensure that most additions of new data occur initially into the main memory, thereby enabling very high rates of data addition. The incidence of successive reads of data from a same disk memory block is increased and the length of time spent in seeking data on the disk is thereby reduced. Segments may be selected for serialization and transfer to the secondary memory without regard to age range of the data or minimal size of the block when main memory is approaching overload.

### FIELD OF THE INVENTION

The Present Invention relates to the organization and storage of information in electronic records by means of information technology systems. More particularly, the Present Invention relates to systems and techniques of data storage and access using data tree structures.

### BACKGROUND OF THE INVENTION

The method of organization of information stored within an electronic archive can greatly effect the average speed with which sought for information can be located within, and retrieved from, the electronic archive. In particular, most prior art optical and magnetic data storage disk devices organize data-records into individuated blocks of data and record each individuated block into a separate and physically contiguous sequence of memory locations. The average seek time required to locate a block storing a sought-for data-record stored on a data storage disk might be on the order of 10 milliseconds, while the average additional time required to locate a second sought-for data-record stored internally within the same block might be on the order of 100 microseconds. In contrast, the average search time required to find two data-records located on two different contiguous blocks of this exemplar data storage disk would typically be at least as large as two average block seek times of 10 milliseconds and might therefore be on the order of 20 milliseconds (i.e., two block seek times of 10 milliseconds each), while the average search time required to find two data-records stored within the same contiguous block would be on the order of 10.1 milliseconds (i.e., one average block seek time of 10 milliseconds to locate the first data-record and an average internal seek time of 100 microseconds to locate the second data-record).

The average time required to search for information stored on a data storage disk can therefore by decreased when the method of grouping the data-records into individuated blocks increases the likelihood of occurrence that all the information required to satisfy a search of the archived data is stored in data-records stored within the fewer contiguous blocks of sequential memory locations of the disk. In other words, data structures that that reduce the average number of block seeks per query tend to be more time efficient.

In certain prior art data archiving techniques, certain data-records are formatted to contain an information received from an electronic message, as well as a plurality of dimensional parameters. The index values of each the dimensional parameters may be extracted from, derived from, or related to the electronic message and/or the contents of the information of the electronic message. The data-records are then associated and clustered in an R-tree data structure on the basis of the index values of the dimensional parameters.

The prior art R-tree data structure is formed with tree branches (i.e., hierarchically structured subsets of intermediate nodes and leaf nodes) extending from a root node. The root node contains pointers to each first node of each tree branch. Branches may contain sub-branches and leaf nodes. The data-records are linked to leaf nodes and are clustered within the R-tree at least partly on the basis of the index values of the dimensional parameters of the data-records. Bounding rectangles are posited as an abstraction of the efficiency dynamics of R-trees, wherein an n-dimensional “rectangle” structure is generated and evolved to associate data-records for more efficient storage and retrieval. The R-tree structure rules typically require that anyone node within the R-tree have a maximal number of directly subordinate nodes. As the R-tree expands to contain more information, the nodes will split as required to not exceed the limitation of directly subordinate nodes while organizing the nodes within prior art rules for selecting and modifying the bounding dimensions of the nodes to support efficient storage, discovery and retrieval of data.

Information stored in electronic messages and records generated by a computer, or received by the computer via a computer network, are often stored within data-records that are first stored in a main memory of the computer and then transferred for archival into a secondary memory, such as an optical or magnetic data storage device. The method by which the data-records are associated and recorded in both the main memory and the secondary memory can significantly determine the efficiency, with which information contained within these data-records is stored, searched for, accessed, and retrieved.

The efficient operation of a computer typically requires availability of the storage capacity of the main memory in order to execute numerous critical processes. It is therefore a general principle of computer design and operation that the storage capacity of the main memory not be committed to archiving information, but rather that the main memory remain generally as available as possible for use by the central processing unit.

In contrast, the secondary memory of a computer is usually configured to provide memory capacity sufficient for archiving large volumes of information. Secondary memories are typically less costly than main memories on a cost per storage capacity comparison, but secondary memories also usually perform at a slower rate of accessibility by the central processing unit of the computer. In addition, the organization of the information as stored in a secondary memory can effect the time required to successfully conclude the search and retrieval of elements of the information from the secondary memory.

Most computers and information network devices generate a plurality of records of their activity and of the activity of users and network traffic. For example, computers may log users' access, network routers may log executed and observed traffic activity, and computer intrusion detection systems may log suspected malicious activity. Such data may be voluminous and organizations sometimes desire to store records of intrusion detection information and information system activity for months or years. The archives of electronic records containing information are often therefore stored on peripheral devices that have expandable storage capacity.

It is therefore a long-felt need in the art to provide systems and methods that enable improved time efficiency in the searching, locating and analysis of data-records of information, such as information technology network activity and security events.

### SUMMARY OF THE INVENTION

Towards this object, and other objects that will become obvious in light of the Prior Art and the present disclosure, the Method of the Present Invention provides a system and method to organize and store data by means of information technology systems, such as a computer and an electronic communications network.

According to the Method of the Present Invention, the data is associated in a data structure in a main memory of a computer in a methodology that increases the likelihood that information closely related within the data structure will be of interest to a same query. Segments of the data structure are then defined and separated from the main memory and stored in contiguous series of memory locations within a secondary memory, e.g., an optical or magnetic disk.

In a first preferred embodiment of the Method of the Present Invention (hereafter “first method”) a computer receives information contained within one or more electronic messages and stores some or all of the information in formatted data-records (hereafter “events”). Each event includes, information, an index value T_E of a time parameter T, and at least one additional index value. The index values of the events may be parametric values or value indications that may be either extracted or derived from an electronic message and/or the information contained in an electronic message, and/or other information related to the message, an information technology activity, or an information technology system.

The events may be stored in a tree data structure, e.g., an R-tree or other suitable data tree structures known in the art, and immediately maintained in a main memory of the computer. The nodes of the tree contain one or more index value pairs that include the minimum and maximum values of selected index values of all events subordinate to the instant event. Each node may contain a time-parameter index value pair of T_E values comprising the most recent time value T_R and the most aged value T_A of all events subordinate to the instant node.

As the tree increases in size, branches and sub-branches are defined as segments and separated from the tree. Each segment is serialized for storage in a separated and individuated contiguous block of memory locations of a secondary memory. The contiguous block of memory locations storing a serialized segment may, in certain alternate preferred embodiments of the present invention, be located on a data storage disk of a secondary memory.

In certain preferred alternate embodiments of the Method of the Present Invention a data tree is generated and maintained within a main memory of a computer wherein the root, branch and intermediate nodes are generally constrained to have at least two and typically no more than six directly subordinate nodes, and the leaf nodes of the tree are generally constrained to have at least two and typically no more than six associated events. As events are added to the data tree of the main memory and the rules governing the generation of the data tree require that nodes be split, the two nodes resulting from the split, and optionally at least some of the nodes subordinate to these two resultant nodes, are examined to identify and select segments of the tree for storage in a secondary memory of the computer. Nodes thereby examined and meeting the conditions of (a.) requiring a memory size within the bounds of an M_MAX memory size and an M_MIN memory size to store the examined node and all nodes and events subordinate to the examined node in the secondary memory, and (b.) having a T_R less than a certain T_E time value, and are then identified as defining a segment of the tree suitable for archiving in the secondary memory. A segment extending from an instant node may thus be selected for secondary memory storage, the segment comprising the instant node and that node's subordinate nodes and events. A selected segment is serialized for storage within a contiguous block of memory locations of the secondary storage, and the serialized segment is read into the secondary memory. The memory locations of the main memory used to store the nodes and events of the segment are made available for use by the computer.

Alternatively or additionally, certain still alternate preferred embodiments of the Method of the Present Invention further comprise a technique for selecting segments of a data tree without requiring the occurrence of a node split. One or more nodes of a data tree may be examined to identify segments requiring no more than M_MAX contiguous storage locations in the secondary memory, and optionally (a.) having a T_R index value less than a certain time value, and/or (b.) requiring at least M_MIN contiguous storage locations in the secondary memory. The transfer of events from storage in the main memory to archiving in the secondary memory may be motivated by intent to more rapidly clear the main memory for access by the computer in performing other operations, and/or where the main memory is reaching an overload state.

In certain yet alternate preferred embodiments, at least some events, and/or electronic messages from which events are at least partially extracted or derived, are received by the computer via an electronics communications network, e.g. the Internet or a telephony system.

Certain additional alternate preferred embodiments of the Method of the Present Invention comprise an R-tree instantiated within the main memory . . . .

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a schematic diagram of an R-Tree data structure has created and maintained in accordance with the first method;

FIG. 2 is a schematic of a node format of the R-Tree of FIG. 1;

FIG. 3 is a schematic of an event stored in the R-Tree of FIG. 1;

FIG. 4 is a schematic of a computer having a main memory storing the R-Tree of FIG. 1;

FIG. 5 is a schematic of electronic communications network comprising the computer of FIG. 4 and communicatively coupled with the Internet;

FIG. 6 is a schematic of a security event format that may be stored in the R-tree of FIG. 1;

FIG. 7 is a process chart of the first method that is executable by means computer of FIG. 4;

FIGS. 8A and 8B are a flowchart of a method of selection of a segment of the R-Tree of FIG. 1 for storage on a secondary memory of the computer of FIG. 4 in accordance with the first method;

FIG. 9 illustrates a method for serializing a segment of the R-Tree of FIG. 1 for storage in the secondary memory of the computer of FIG. 4;

FIG. 10 is a flowchart of a variation of the first method that includes a process of transferring branches and sub-branches, i.e. segments of the R-Tree of FIG. 1 from the main memory to the secondary memory of the computer of FIG. 4 when the main memory is reaching an overload state;

FIG. 11 is an alternate variation of the process of FIG. 10 wherein serialized segments requiring a memory size no greater than M_MAX inclusively and having a set maximum T_R;

FIG. 12 is an alternate variation of the process of FIG. 10 wherein serialized segments requiring a memory size between M_MIN and M_MAX inclusively may be stored without regard for the T_R value of the segment; and

FIG. 13 is a schematic of a serialized segment of the R-Tree of FIG. 1 as stored in a block of contiguous memory locations of a data storage disk of the computer of FIG. 4.

### DETAILED DESCRIPTION OF PREFERRED EMBODIMENTS

The following description is provided to enable any person skilled in the art to make and use the invention and sets forth the best modes contemplated by the inventor of carrying out his or her invention. Various modifications, however, will remain readily apparent to those skilled in the art, since the generic principles of the Present Invention have been defined herein.

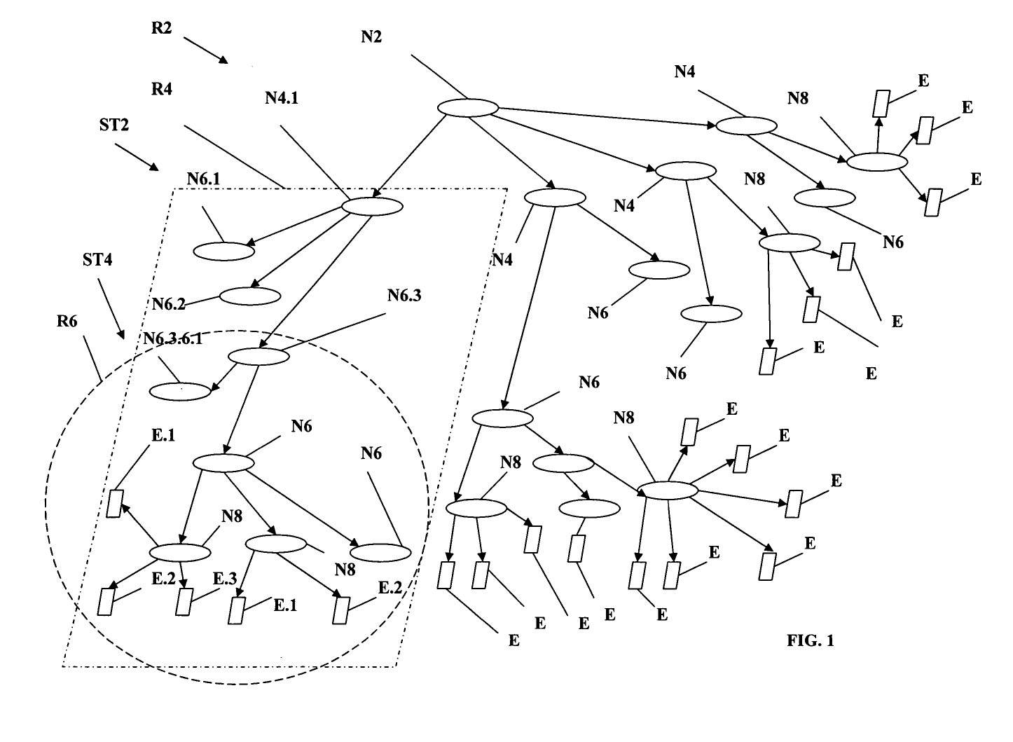

Referring now generally to the Figures and particularly to FIG. 1, FIG. 1 is a schematic diagram of an R-Tree data structure R2 (hereafter “R-Tree”) that is instantiated and maintained in accordance with the first method and the prior art. The R-tree R2 includes a plurality of nodes N2-N8, to include a root node N2, branch nodes N4, intermediate nodes N6, leaf nodes N8 and events E. These R-tree nodes N2-N8 and events E form branches R4 and sub-branches R6.

It is understood that each event E is subordinate to an individual leaf node N8, except in rare cases where an event E is immediately subordinate to a branch node N4, or even more rarely where an event E is immediately subordinate to a root node N2. The term “subordinate” is defined herein to indicate a relationship existing between two nodes wherein a first and superior node is linked by one pointer P1-P6 of a node 4-8, or a chain of pointers P1-P6 of intermediate nodes N6, to a memory address of a second node, whereby the second node is subordinate to the first node. In particular, all branch nodes N4 are subordinate to the root node N2. Each intermediate node N6 is subordinate to both the root node N2 and one and only one branch node N4, and possibly one or a plurality of intermediate nodes N6. Each leaf node N8 is subordinate to the root node N2, no more than one branch node N4, and possibly one or more intermediate nodes N6.

Each R-tree branch R4 includes an originating branch node N4 and all intermediate nodes N6, leaf nodes N8 and events E subordinate to the instant originating branch node N4. Each R-tree sub-branch R6 includes an originating intermediate node N6 and all intermediate nodes N6, leaf nodes N8 and events E subordinate to the instant originating intermediate node N6.

For the sake of clarity, certain intermediate nodes R6 are shown in FIG. 1 without subordinate leaf nodes N8 or events E; the suppression of these symbols is affected in FIG. 1 to reduce the complexity of the FIG. 1 by eliminating repetitive detail.

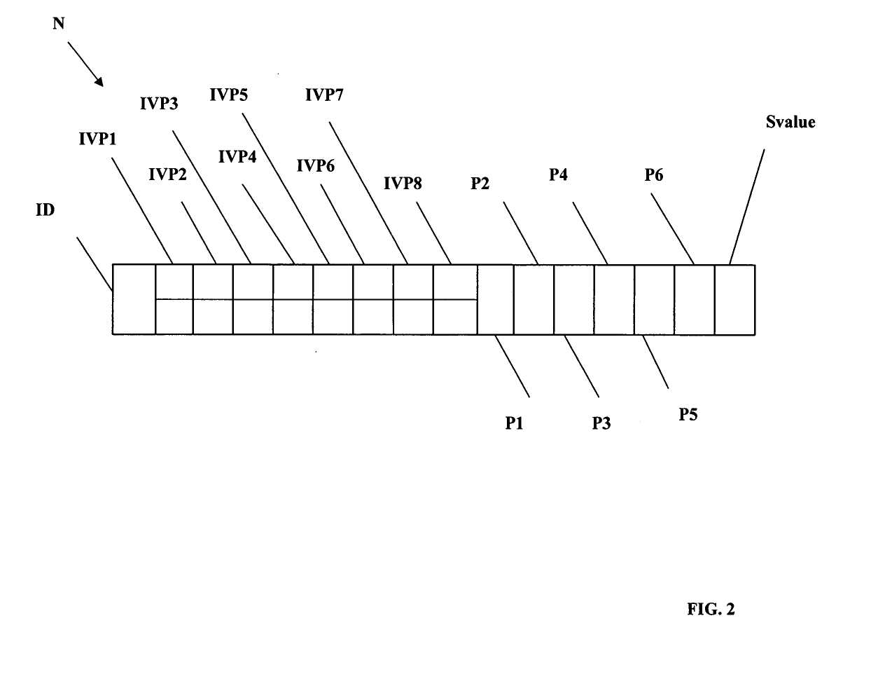

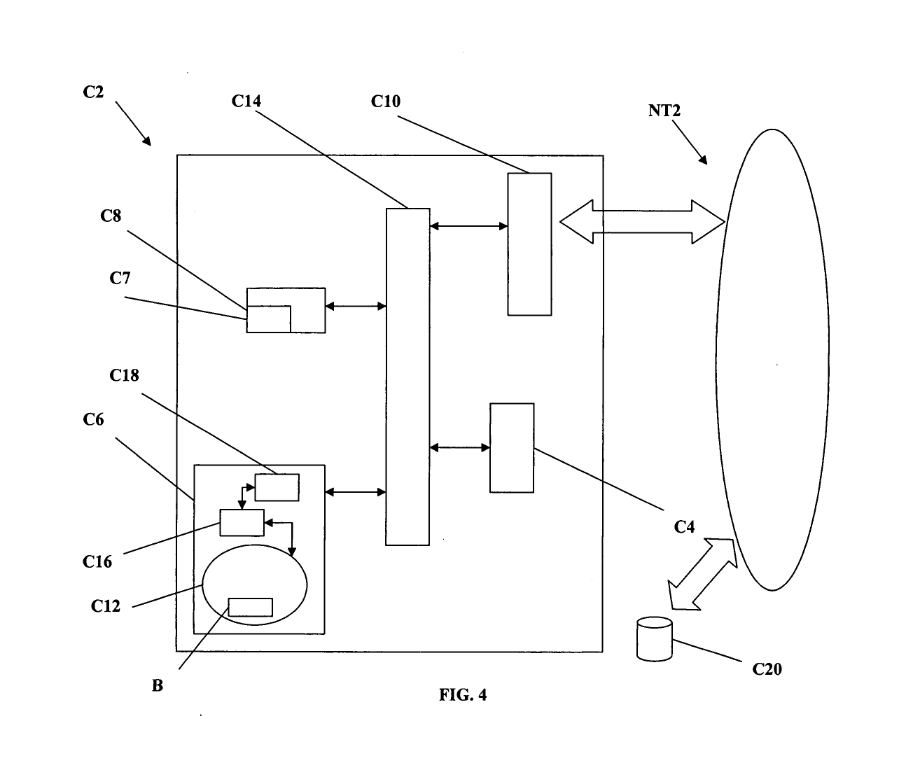

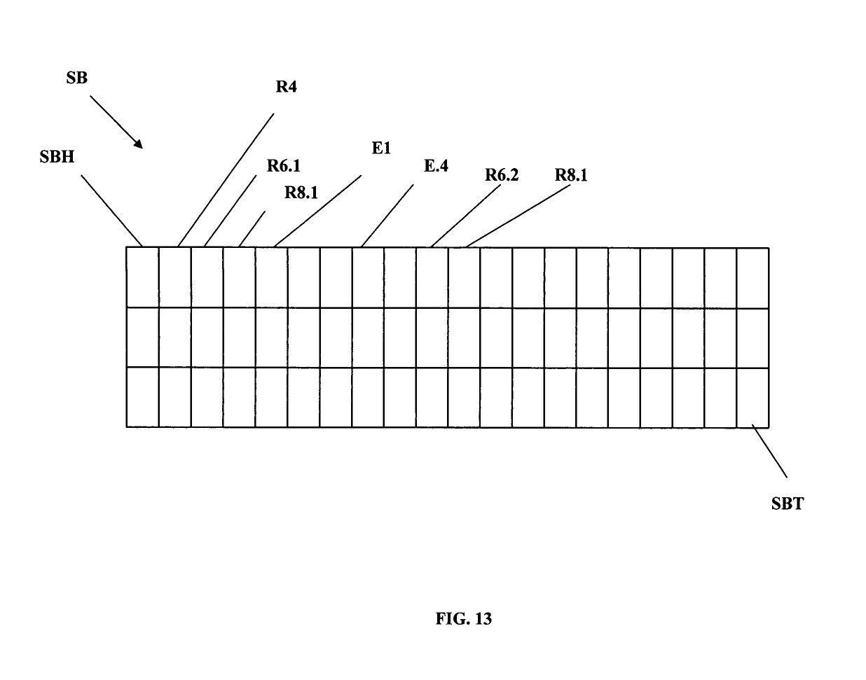

Referring now generally to the Figures and particularly to FIGS. 1 and 2, FIG. 2 is a schematic of a possible data structure N of a node N2-N8. In the first method, each node N2 through N8 conforms to a prior art R-tree data structure and is identified by an identifier ID 2. The node contains index value pairs IVP1 through IVP8 and pointers P-P6. It is understood that the number of index value pairs IV1-8 and pointers P1-P6 contained in each node N2-N8 may vary in various alternate preferred embodiments of the Method of the Present Invention. The pointers P1-P6 of the root node N2, branch nodes N4 and intermediate nodes N6 are, or comprise, memory addresses in a main memory C2 of a computer C4 (as per FIG. 4) where subordinate nodes N2-N8 and subordinate events E are at least temporarily stored. The pointers P1-P6 of the leaf nodes N8 are, or comprise, memory addresses in the main memory C2 where events E are recorded. Each value S of the nodes N2-N8 indicate the quantity of memory size required in the secondary memory C6 to store the instant node N2-N8, all subordinate nodes N4-N8, and all subordinate events. The S value of a selected node N2-N8 may be examined by the computer C4 to determine if a branch R4 or a sub-branch R6 originated by the selected node N2-N8 and its subordinate nodes N4-N8 and events E may be stored as a serialized segment SB (as per FIG. 13) in temporarily in a cache memory C7 and also in a contiguous series of memory locations of the secondary C6 of the computer C4.

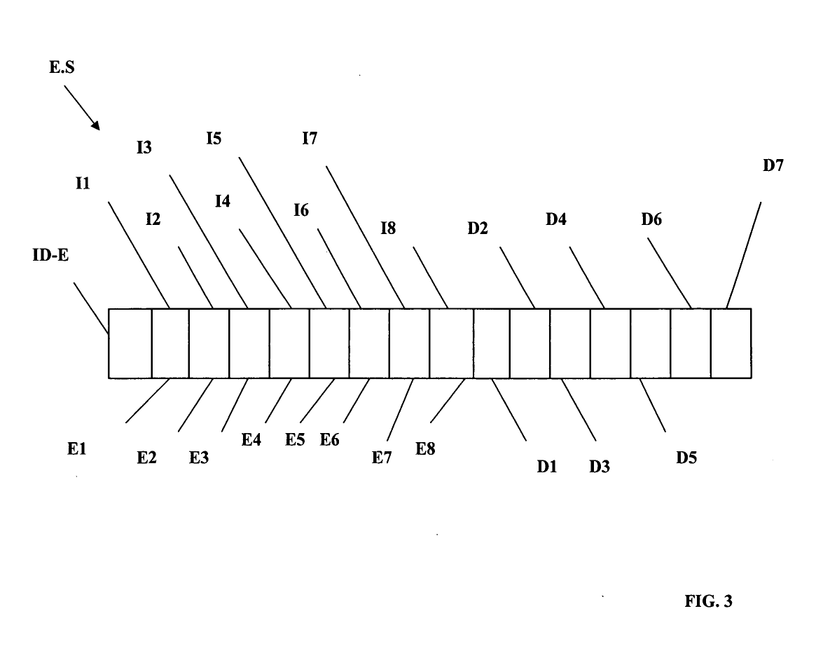

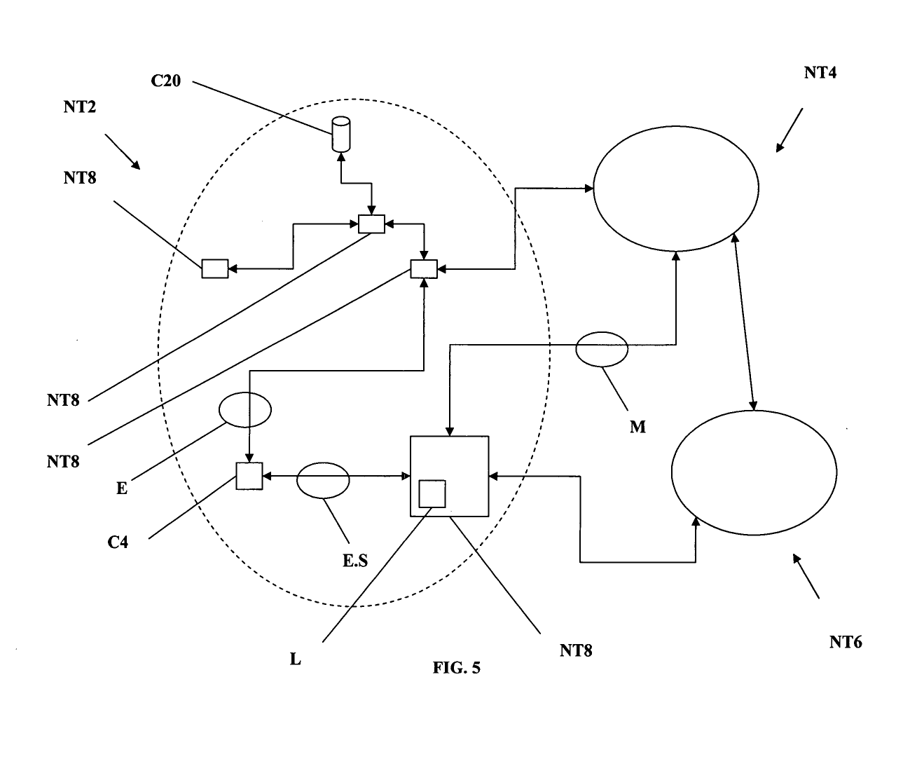

Referring now generally to the Figures and particularly to FIG. 3, each event E contains an event identifier ID-E, a plurality of Index Values I1 through I8 and one or more information D1-D7. The index values I1-I8 and the information D1-D7 may be extracted from and/or partially derived from an electronic message M (as per FIG. 5). The index value I1 is the event time value T^{e.}

Referring now generally to the Figures and particularly to FIGS. 4 and 5, FIG. 4 is a schematic of the computer C4 of the electronic communications network NT2 of FIG. 5. The R-Tree R2 is instantiated and maintained in the main memory C2 of the computer C4. The computer C4 also includes a central processing unit C8 comprising the cache memory C7, a network interface C10, the main memory C2 and the secondary memory C6. Either of the segments ST2 and ST4 (as per FIG. 1) may be separated from the R-tree R2, serialized by the computer C4 and one of the stored in a contiguous block B of a data storage disk C12 of the secondary memory C6. The serialized segment SB of the R-tree R2 may be stored in the cache memory C7 prior to writing the serialized segment SB to the secondary memory C6.

A communications bus C14 of the computer system C4 bi-directionally communicatively couples the central processing unit C8, the cache memory C7, the network interface C10, the main memory C2 and the secondary memory C6. The secondary memory C6 includes the data storage disk C12, a disk motor C16 and a controller C18. The controller C18 reads and writes data to and from the data storage disk C12 and the central processing unit C8 (hereafter “CPU” C8). The controller C18 additionally directs the operations of the disk motor C16 to enable the reading and writing to and from the data storage disk C12.

The main memory C2 of the computer system C4 includes high speed memory electronics that are typically more expensive that the components of the secondary memory C6. The main memory C2 may also be used by the computer system C4 to execute a variety of computational functions, such as running an operating system of the computer system C4 and performing basic input-output operating system functions.

The secondary memory C6 may be a lower cost memory storage device, such as a peripheral device that includes a library of one or more optical or magnetic memory disks C12. A contrast of the qualities and characteristics of the main memory C2 and the secondary memory C6 of the computer system C4 typically surfaces these common, but not necessary, distinctions:
the CPU C8 reads from and writes to the main memory C2 faster than to the secondary memory C6;
the main memory C2 is required for use by the CPU 10 in performing critical operational functions and can not be dedicated solely to storage of events E;
the memory capacity of the secondary memory C6 may be more easily and less expensively increased than the memory capacity of the main memory C2 may be expanded; and
the secondary memory C6 may be provided in certain preferred embodiments of the method of the present invention as one or more peripheral devices, libraries of magnetic or optical disks C12, and/or memory storage systems C20 coupled with the communications network NT2 (as per FIG. 5).

Referring now generally to the Figures and particularly to FIG. 5, FIG. 5 presents an electronic communications network NT2 including the computer system C4 and memory storage systems C20. The communications network NT2 may be communicatively coupled with an external computer network NT4. The communications network NT2 and the external computer network NT4 are capable of supporting digital electronics message traffic and may be, comprise, or be comprised within, an electronics communications network such a telephony network, a computer network, an intranet, and an extranet and/or the Internet NT6.

A plurality of network computers NT8 of the communications network NT2 receive electronic messages M originating from within the communications network NT2, from the external computer network NT4 and/or the Internet NT6. Optionally, additionally or alternatively, one or more electronic messages M of the message traffic received by the computer C4 may be generated by the computer C4 itself, one of the network computers NT8, the Internet NT6, and/or the external computer network NT4.

One or more messages M may optionally contain information that related to the activity of the communications network NT2, external network NT4, an unauthorized attempt of intrusion targeting the communications network NT2, and/or a possible unauthorized attempt of intrusion targeting the communications network NT2.

The computer C4 may receive events E, and alternatively or additionally messages M from which events E may be at least partially derived. The events E and the messages M may be communicated to the computer C4 from the external computer network NT4 and/or the network computers NT8 via the communications network NT2. The communications network NT2 and the external computer network NT4 may be, comprise, or be comprised within, an electronics communications network such a telephony network, an intranet, and extranet and/or the Internet NT6.

Referring now generally to the Figures and particularly to FIG. 3, each event E contains a plurality of index values I1 through I8 and one or more information D1-D7. The syntax of the event E organizes the storage of index values I1 through I8 of individual and separate bounding dimensions, including a time dimension I1, and optionally other data, such as representations of information contained in an electronic message M associated with a related security event. When generated under communications protocols common to Internet NT6 communications, an electronic message M may contain messaging information in conformance with the Internet Protocol (hereafter “IP”). For example, an electronic message M received by a network computer NT8 from the Internet NT6 via the external computer network NT4 may contain the index values I1-I8 of a time T dimension I1, an event type ET dimension I2, an IP source address I3, and IP destination address I4, and a destination port number I5, sourcing switch/physical port dimension I6, event priority dimension I7, and optionally one or more an additional dimensions I8.

Referring now generally to the Figures and particularly to FIGS. 2 and 3, each index value pair IVP1-IVP8 of each node R2-8 contains maximum index values I1max-I8max and minimum index values I1min-I8min of one distinct bounding dimension. The values I1max-I8max and I1min-I8min of the index value pairs IVP1-IVP8 of each node N2-N8 are bounding values of the dimensions of all subordinate nodes N4-N8 and events E of the instant node N2-N8. For example, I1min and I1max are respectively minimum and maximum index values of the time dimension T and I2min and I2max are respectively minimum and maximum index values of the event type ET dimension.

In the case of the root node N2, the maximum index values Imax1-Imax8 are each the highest value of the relevant dimension held by any event E stored within the data tree R2. The pairs of parametric values IVP1-IVP8 contain in the first method according to the following dimensions:
IVP1—time dimension, where I1max (or “T_R”) is the most recent time value and I1min (or “T_A”) is the most previous time value of all of the events stored in the R-Tree R2;
IVP2—event ET dimension, where I2max is the alpha-numerically largest event type ET designator and I2min is the alpha-numerically smallest event type ET designator of all of the events stored in the R-Tree R2;
IVP3—source IP address dimension, where I3max is the alpha-numerically largest source IP designator and I3min is the alpha-numerically smallest source IP designator of all of the events stored in the R-Tree R2;
IVP4—destination IP address dimension, where I4max is the alpha-numerically largest source IP address designator and I4minx is the alpha-numerically smallest source IP address designator of all of the events stored in the R-Tree R2;
IVP5—destination IP port dimension, where I5max is the alpha-numerically largest source IP port designator and I5min is the alpha-numerically smallest source IP port designator of all of the events stored in the R-Tree R2;
IVP6 sourcing switch/physical port dimension, where I6max is the alpha-numerically largest sourcing switch/physical port designator and I6min is the alpha-numerically smallest sourcing switch/physical port designator of all of the events stored in the R-Tree R2;
IVP7—event priority dimension, where I7max is the alpha-numerically largest event priority designator and I7min is the alpha-numerically smallest event priority designator of all of the events stored in the R-Tree R2; and
IVP8—additional dimension, where I8max is the alpha-numerically largest designator and I8min is the alpha-numerically smallest designator of an additional dimension of all of the events stored in the R-Tree R2.

The index values stored in the nodes N2-N8 stored within the data tree R2 are interpreted in accordance with the first method as bounding dimensions IVP1-IVP8 of index values I1-I8 of distinct dimensions in accordance with the prior art operation of R-tree generation, use and maintenance.

In the case of each branch node N4 of the exemplary R-tree R2 of FIG. 1, the maximum index values Imax1-Imax8 are each the highest value of the relevant dimension held by any event E subordinate to the relevant branch node N4. The pairs of parametric values IVP1-IVP8 of each branch node N4 contain, and in accordance with the first method, the following dimensions:
IVP1—time dimension, where I1max is the most recent time value T_R and I1min is the most previous time value T_A of all of the events E subordinate to the branch node N4;
IVP2—event dimension, where I2max is the alpha-numerically largest event type designator and I2max is the alpha-numerically smallest event type designator EVENT TYPE of all of the events E subordinate to the branch node N4;
IVP3—source IP address dimension, where I3max is the alpha-numerically largest source IP designator and I2min is the alpha-numerically smallest source IP designator of all of the events E subordinate to the branch node N4;
IVP4—destination IP address dimension, where I4max is the alpha-numerically largest source IP address designator and I4min is the alpha-numerically smallest source IP address designator of all of the events E subordinate to the branch node N4;
IVP5—destination IP port dimension, where I5max is the alpha-numerically largest source IP port designator and I5max is the alpha-numerically smallest source IP port designator of all of the events E subordinate to the branch node N4;
IVP6 sourcing switch/physical port dimension, where I6max is the alpha-numerically largest sourcing switch/physical port designator and I6min is the alpha-numerically smallest sourcing switch/physical port designator of all of the events E subordinate to the branch node N4;
IVP7—event priority dimension, where I7max is the alpha-numerically largest event priority designator and I7min is the alpha-numerically smallest event priority designator of all of the events E subordinate to the branch node N4; and
IVP8—additional dimension, where I8max is the alpha-numerically largest designator and I8min is the alpha-numerically smallest designator of an additional dimension all of the events E subordinate to the branch node N4.

In the case of each intermediate node N6 of the exemplary R-tree R2 of FIG. 1, the maximum index values Imax1-Imax8 are each the highest value of the relevant dimension held by any event E subordinate to the relevant intermediate node N6. The pairs of parametric values IVP1-IVP8 contain, and in accordance with the first method, the following dimensions:
IVP1—time T dimension, where I1max is the most recent time value T_R and I1min is the most previous time value T_A of all of the events E subordinate to the intermediate node N6;
IVP2—event type ET dimension, where I2max is the alpha-numerically largest event type designator and I2min is the alpha-numerically smallest event type designator of all of the events E subordinate to the intermediate node N6;
IVP3—source IP address dimension, where I3max is the alpha-numerically largest source IP designator and I2min is the alpha-numerically smallest source IP designator of all of the events E subordinate to the intermediate node N6;
IVP4—destination IP address dimension, where I4max is the alpha-numerically largest source IP address designator and I4min is the alpha-numerically smallest source IP address designator of all of the events E subordinate to the intermediate node N6;
IVP5—destination IP port dimension, where I5max is the alpha-numerically largest source IP port designator and I5min is the alpha-numerically smallest source IP port designator of all of the events E subordinate to the intermediate node N6;
IVP6 sourcing switch/physical port dimension, where I6max is the alpha-numerically largest sourcing switch/physical port designator and I6min is the alpha-numerically smallest sourcing switch/physical port designator of all of the events E subordinate to the intermediate node N6;
IVP7—event priority dimension, where I7max is the alpha-numerically largest event priority designator and I7min is the alpha-numerically smallest event priority designator of all of the events E subordinate to the intermediate node N6; and
IVP8—additional dimension, where I8max is the alpha-numerically largest designator and I8min is the alpha-numerically smallest designator of an additional dimension all of the events E subordinate to the intermediate node N6.

In the case of each leaf node N8 of the exemplary R-tree R2 of FIG. 1, the maximum index values Imax1-Imax8 are each the highest value of the relevant dimension held by any event E Subordinate to the relevant leaf node N8. The pairs of parametric values IVP1-IVP8 contain, and in accordance with the first method, the following dimensions:
IVP1—time T dimension, where I1max is the most recent time value T_R and I1min is the most previous time value T_A of all of the events E subordinate to the leaf node N8;
IVP2—event type ET dimension, where I2max is the alpha-numerically largest event type designator and I2min is the alpha-numerically smallest event type designator of all of the events E subordinate to the leaf node N8;
IVP3—source IP address dimension, where I3max is the alpha-numerically largest source IP designator and I3min is the alpha-numerically smallest source IP designator of all of the events E subordinate to the leaf node N8;
IVP4—destination IP address dimension, where I4max is the alpha-numerically largest source IP address designator and I4min is the alpha-numerically smallest source IP address designator of all of the events E subordinate to the leaf node N8;
IVP5—destination IP port dimension, where I5max is the alpha-numerically largest source IP port designator and I5min is the alpha-numerically smallest source IP port designator of all of the events E subordinate to the leaf node N8;
IVP6 sourcing switch/physical port dimension, where I6max is the alpha-numerically largest sourcing switch/physical port designator and I6min is the alpha-numerically smallest sourcing switch/physical port designator of all of the events E subordinate to the leaf node N8;
IVP7—event priority dimension, where I7max is the alpha-numerically largest event priority designator and I7min is the alpha-numerically smallest event priority designator of all of the events E subordinate to the leaf node N8; and
IVP8—additional dimension, where I8max is the alpha-numerically largest designator and I8min is the alpha-numerically smallest designator of an additional dimension all of the events E subordinate to the leaf node N8.

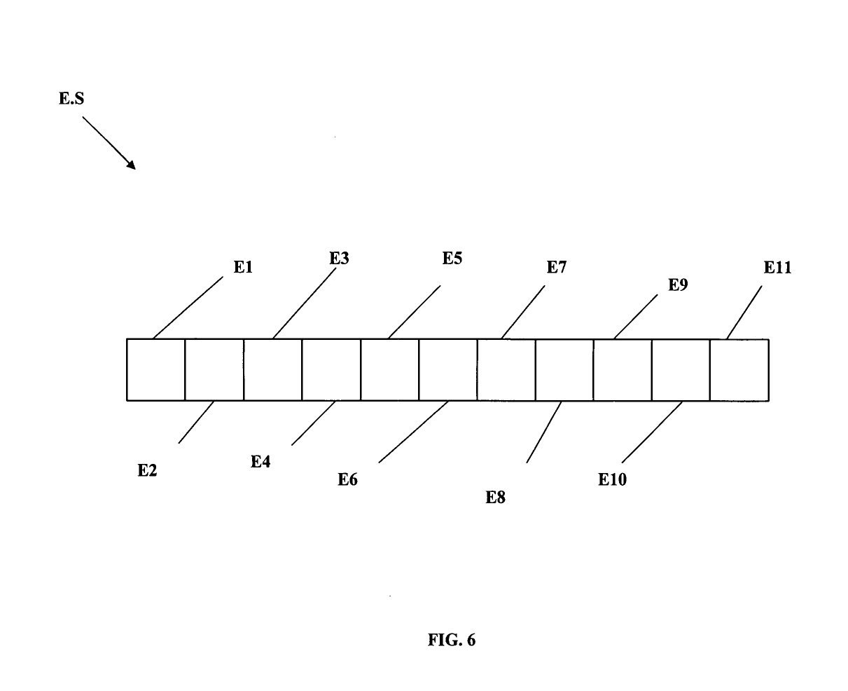

Referring now generally to the Figures and particularly to FIG. 6, in certain alternate variations of the Method of the Present Invention, the network computers NT8 are programmed to detect unauthorized intrusion attempts. To this end, the network computers NT8 analyze the contents of electronic messages M and generate security events E.S containing security event information when an incoming electronic message M has indications of being part of an attempted intrusion.

In certain prior art methods of intrusion detection, information stored in an electronic message M or associated with the conditions of receipt of the electronic message M are compared against a library L of intrusion indications stored in the network NT2, and an intrusion detection security event E.S is generated when a match is found between one or more entries of an intrusion indication library L and a particular electronic message M. For example, the intrusion detection library L may contain a plurality of signatures of known or suspected indications that the electronic message M may contain at least part of a software worm or virus. When a match is found between an electronic message M and an intrusion detection signature a security event E.S is generated by a network computer NT8, where the security event E.S is formatted as illustrated in FIG. 3 and comprises:
a. an event identifier field ID-E;
b. a time field E1, containing an I1 time index value;
c. event type field E2, containing an I2 ET index value;
d. source IP field E3, containing an I3 index value;
e. destination IP field E4, containing an I4 index value;
f. destination port field E5, containing an I5 index value;
g. sourcing switch/physical port field E6, containing an I6 index value;
h. event priority field E7, containing an I7 index value; and
i. message information field(s) E8, containing an I8 index value.

The time field E1 contains the index value I1 specifying a time of generation of the event. The event type field E2 stores an identification of type of intrusion event indication that matched the electronic message M. The source IP field E3 stores the source IP address designated by the electronic message. The destination IP field E4 records the destination IP address designated by the electronic message. The destination port field E5 stores the destination port designated by the electronic message. The sourcing switch/physical port E6 contains the switch or physical port from which the electronic message was received by the network computer 8 or as was designated by the electronic message. The event priority field E7 records a priority assigned by the network computer NT8 to the security event E.S. One or more message information fields E8 store information stored in, derived from, or related to, the electronic message M, such as raw text as originally contained in the electronic message from which the security event E.S was derived.

In various alternate preferred embodiments of the Method of the Present Invention, one or more messages M may be, comprise, or be comprised within, one more events E and/or security events E.S. Optionally or additionally, the computer system C4 may derive index values I1-I8 from information related to an event E and thereupon associate the generated index values I1-I8 with the event E from which the index values I1-I8 were derived. It is understood that the scope of the term “event” as claimed herein encompasses both events E and security events E.S.

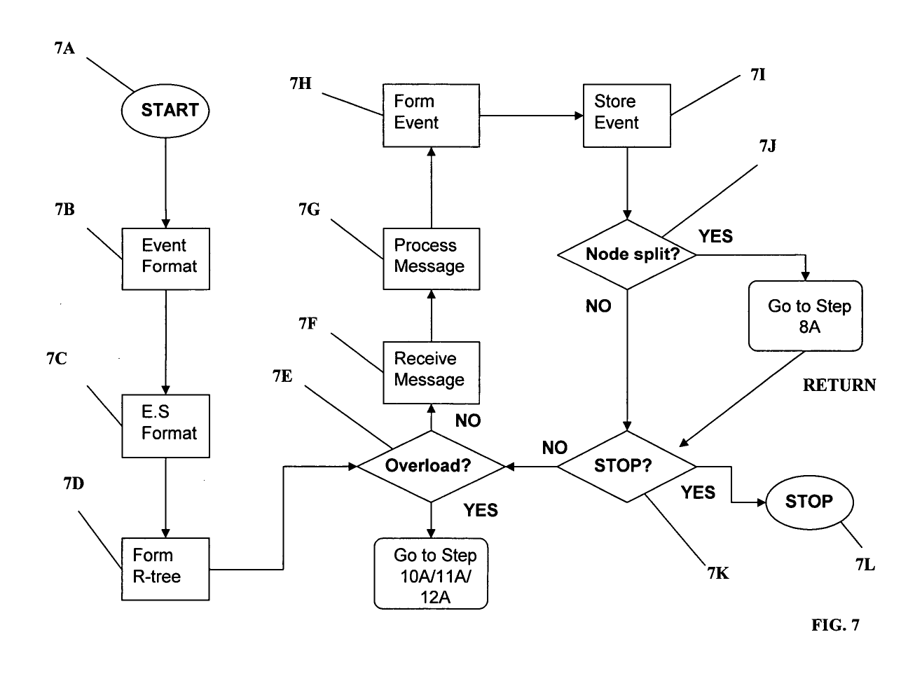

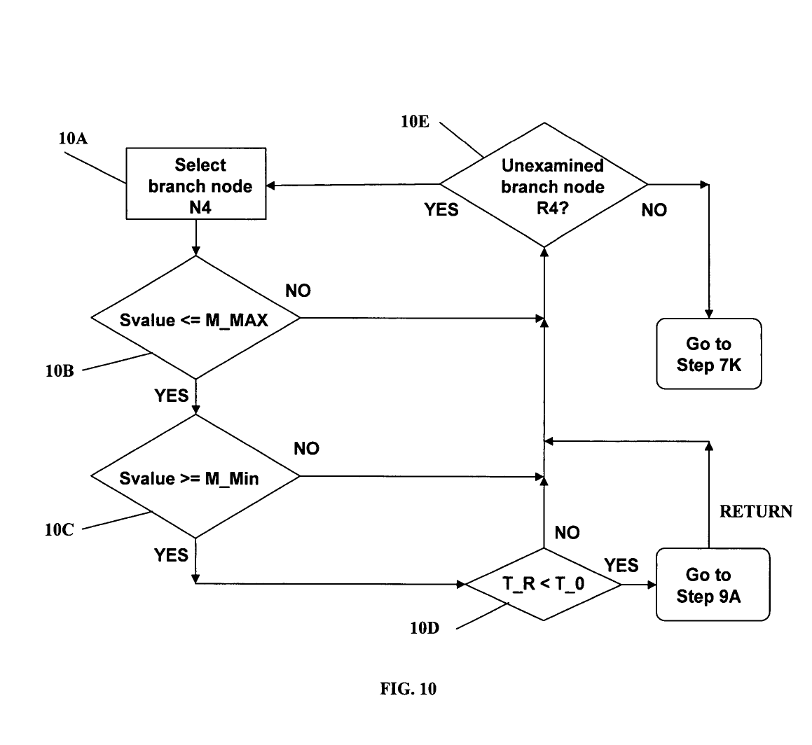

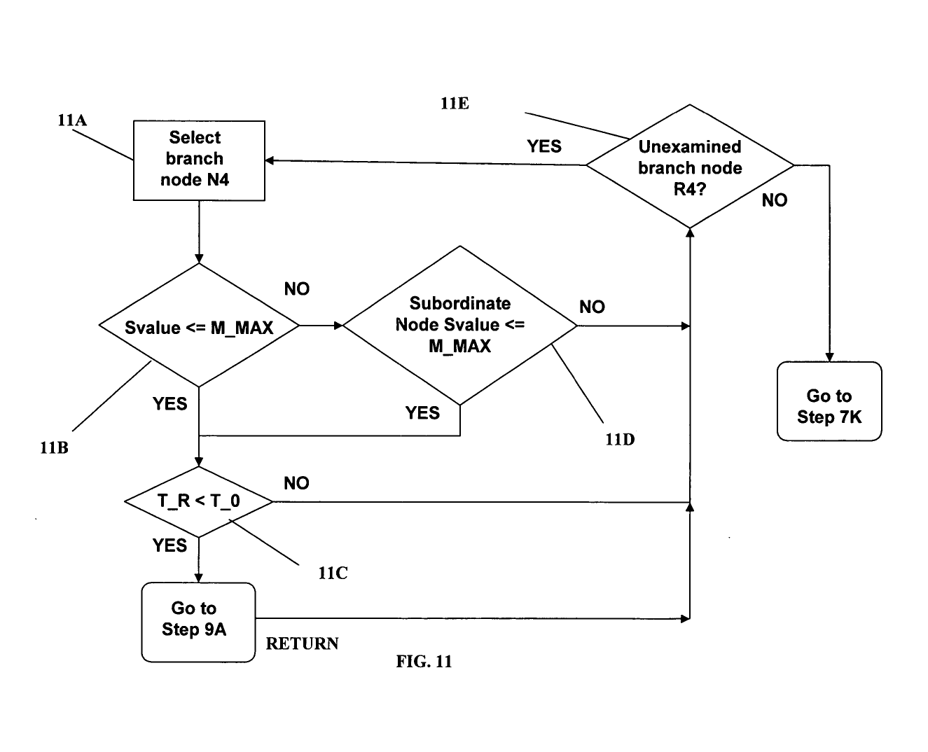

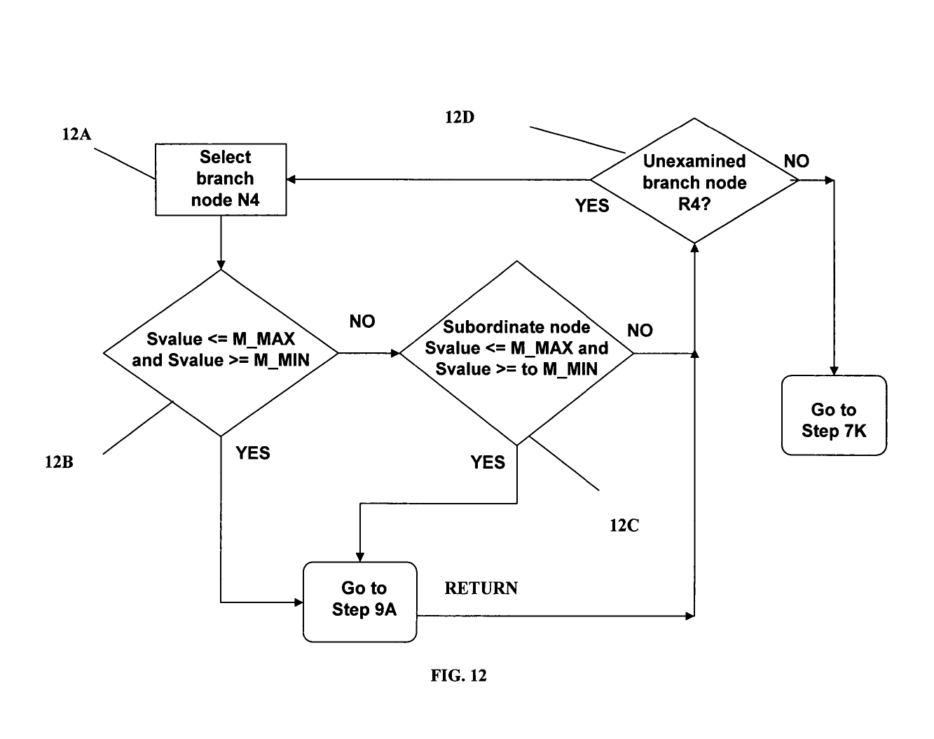

Referring now generally to the Figures and particularly to FIG. 7, FIG. 7 is a process chart of the first method that is executable by means computer C4 of FIG. 4. In step 7.A the computer C4 is powered up. In step 7.B the format for the events E are established. In option step 7.C of FIG. 6 of the security events E.S is established. In step 7.D the R-tree R2 is instantiated. In step 7.E the computer C4 determines if events E & E.S shall be to the secondary memory C6 in an expedited process of FIG. 10, 12, or 12. If the computer C4 determines to expedite the process of selecting transferring segments ST2 and ST4 from the main memory C2 to the secondary memory C6, the computer C4 proceeds on to a step selected from step 10.A of FIG. 10, step 11.A of FIG. 11, or step 12.A of FIG. 12. If not proceeding on to steps 10.A, 11.A or 12.A, the computer C4 proceeds to execute step 7.F to receive a message M, an event E or a security event E.S via the communications network NT2. In optional step 7.G the message M. event E or security event E.S are processed and modified, wherein the computer C4 may execute instructions related or unrelated to the storage of the event E, as well as generating or modifying index values I1-I8 and other content of the event E. In step 7.H the event E is instantiated as the event E will be stored. The event E, which may be a security event E.S and/or at least partially derived from a message M as received in step 7.F, is stored in the R-tree R2, and the index value pairs IVP1-IVP8 of the nodes N2-N8 of the R-tree R2 are updated.

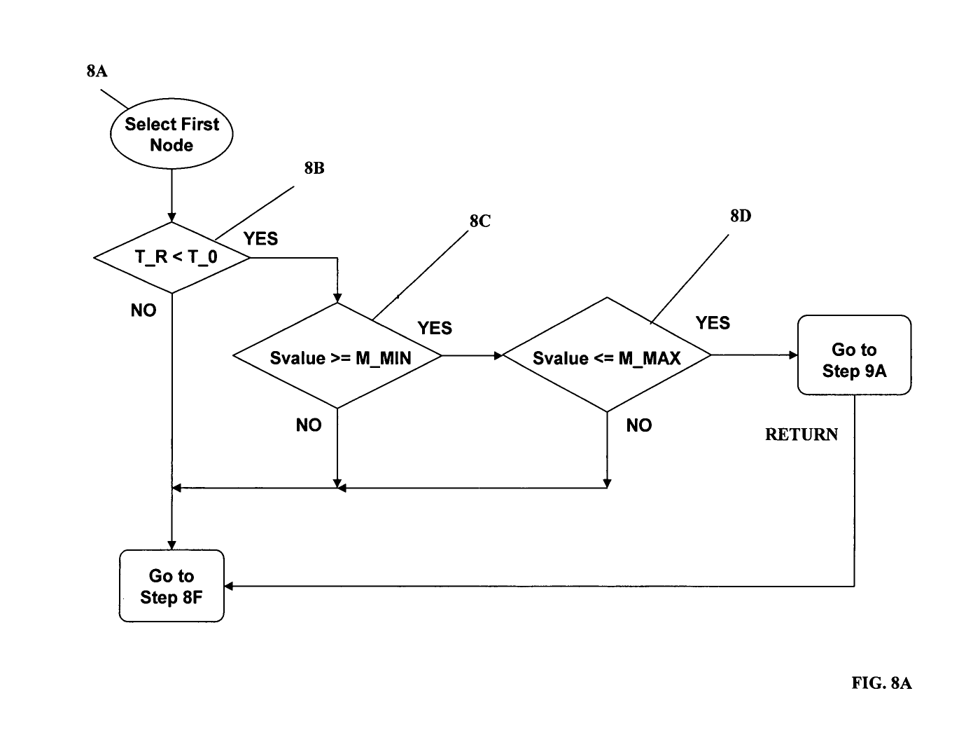

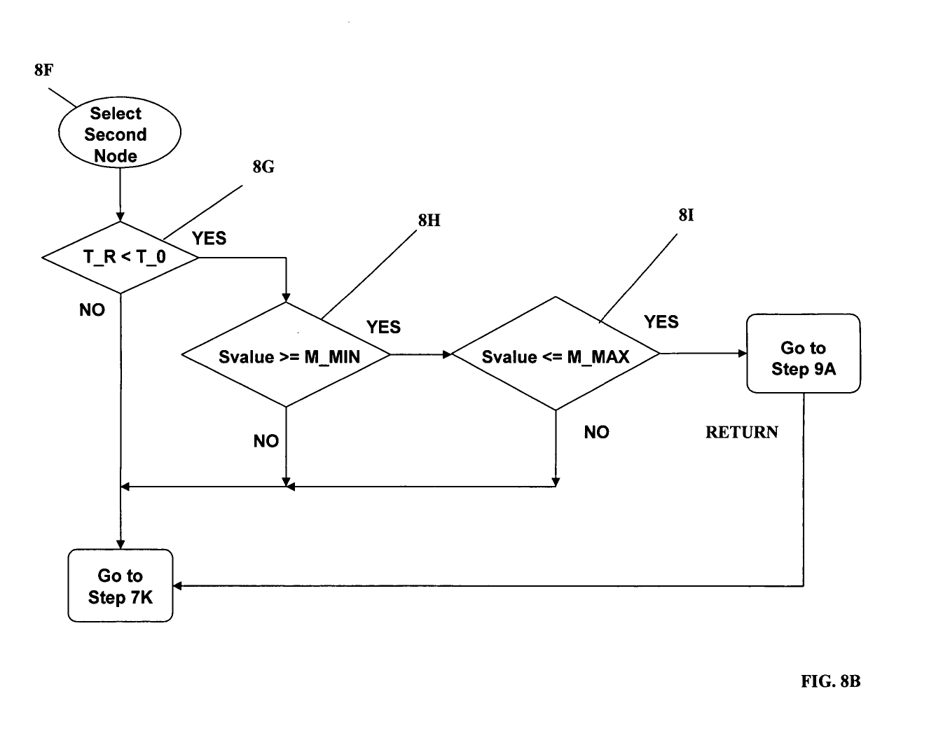

In step 7.J the computer determines if the addition of the event E as performed in step 7.H caused a node N2-N8 to split, as directed by prior art R-tree methodology. Where the computer C4 determines that a node split has occurred, the computer C4 proceeds on to step 8A of FIG. 8. Where no node split is detected by the computer C4, the computer C4 proceeds on to step 7.K to determine if the reception, creation and storage of events E shall continue.

Referring now generally to the Figures and particularly to FIGS. 8A and 8B, FIGS. 8A and 8B are a flowchart of a method of selection of a segment SB of the R-Tree of FIG. 1 for storage on a secondary memory of the computer of FIG. 4 in accordance with the first method. In step 8.A the two nodes N2-N8 of a node split (of step 7.H) are identified. In step 8B a first node N2-N8 of the nodes split in step 7.I (of FIG. 7) is examined to determine if the maximum T_R index value held as the I1max index value of the time IVP1 of the first node of the split is less recent than a specified time T_0. If the I1max index value of the first split node is T_0, than the computer C4 determines in step 8C if the Svalue of the first node is less than equal to an M_MIN value, e.g., 256 Kbytes memory locations. The computer C4 determines in step 8D if a branch R4 originated by the first node is less than or equal to an M_MAX memory size, e.g, 2 Byte memory locations. If the computer C4 determines that the branch R4 originated by the first node of the split has an Svalue between M_MIN and M_MAX inclusive, than the computer C4 proceeds on from step 8D to step 9A and to serialize and transfer the branch R4 to the secondary memory C6. Alternately, if the computer C4 proceeds from step 8D to step 8E and determines that the sub-branch R6 originated by an intermediate node N6 subordinate to the first node of the split has an Svalue between M_MIN and M_MAX inclusive, and has a T_R value less recent than T_0, then the computer C4 proceeds on from step 8E to step 9A and to serialize and transfer the sub-branch R6 to the secondary memory C6.

In step 8F a second node N2-N8 of the nodes split in step 7.H (of FIG. 7) is selected for examination. The computer C4 determines in step 8G if the maximum T_R index value held as the I1max index value of the time IVP1 of the second node N2-N8 of the remaining node resulting from the split of step 7I is less recent than the time T_0. If the I1max index value of this second resultant node of the split of step 7I is less recent than the time T_0, than the computer C4 determines in step 8H if the Svalue of the second node is less than equal to an M_MIN value, e.g., 256 Kbytes memory locations. The computer C4 determines in step 8I if a branch R4 originated by the second node is less than or equal to an M_MAX memory size, e.g, 2 Mbytes of memory locations. If the computer C4 determines that the branch R4 originated by the second node of the split has an Svalue between M_MIN and M_MAX inclusive, than the computer C4 proceeds on from step 8I to step 9A and to serialize and transfer the branch R4 to the secondary memory C6. In addition, if the computer C4 determines that the sub-branch R6 originated by an intermediate node N6 subordinate to the second node of the split has an Svalue between M_MIN and M_MAX inclusive, and has a T_R value less recent than the T time, than the computer C4 proceeds on from step 8J to step 9A and to serialize and transfer the sub-branch R6 to the secondary memory C6.

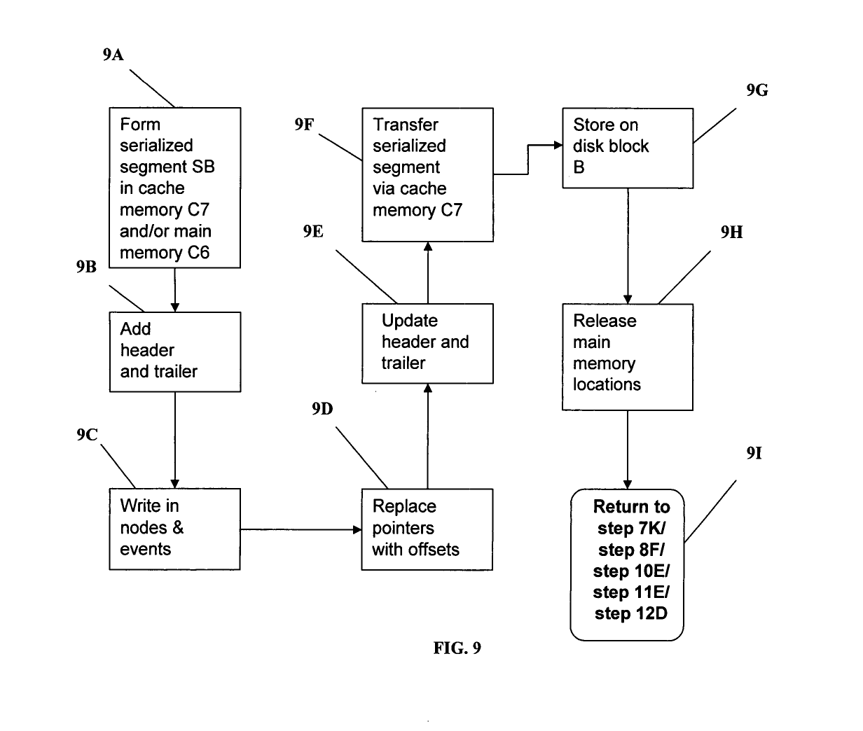

Referring now generally to the Figures and particularly to FIGS. 9 and 13, FIG. 9 illustrates a method for serializing a segment of the R-Tree of FIG. 1 for storage in the secondary memory of the computer of FIG. 4. FIG. 13 is a schematic of the serialized segment SB as stored in cache memory C7 or on a secondary memory C6. In step 9A a serialized segment SB is instantiated in the memory C4 and/or the cache memory C7. A trailer SBT and a header SBH containing a message serial number are added to the serial segment SB in step 9B. In step 9C the originating node R2-R8 of the branch R4 or sub-branch R6 of the segment (as selected in step 8d or 8I) and the subordinate nodes and events of the instant branch R4 or sub-branch R6 are read into the SB format. In step 9D pointers linking each node to directly subordinate nodes R4-R8 and events are replaced with memory location offsets OFF that maintain the links from each node R2-R8 to each node R4-R8 and event E. In step 9E the trailers SBT and headers SBH are updated upon the basis of the content entered into the serialized segment SB in steps 9C and 9D. In step 9F the serialized segment SB is transferred to the secondary memory controller C16 of the secondary memory C6 and additional information may be added to the trailer SBT and header SBH by the secondary memory controller C16. In step 9G the serialized segment SB is read into the data storage disk C12 of the secondary memory C6 and the memory locations of the main memory C2 used for storing the information transferred for storage in the secondary memory C6 are released for other uses by the computer C4. In step 9I the computer C4 returns to either processing a recently split node or to step 7K of the process of FIG. D.

Referring now generally to the Figures and particularly to FIG. 10, FIG. 10 is a flowchart of a variation of the first method that includes a process of examining and possibly transferring segments ST2 and/or ST4 of the R-Tree of FIG. 1 from the main memory to the secondary memory C6 of the computer C4 of FIG. 4 when the main memory C2 is reaching an overload state. The execution of the process of FIG. 10 by the computer C4 expedites transfer of segments ST2 & ST4 of the R-tree R2 from the main memory C2 by removing any branch or sub-branch that is no larger than an M_MAX value, e.g., 2 Mbytes of memory storage, and without regard to the age of the events E transferred for archival outside of the main memory C2. In step 10A a branch node N4 is selected. In step 10B the computer C4 determines if the Svalue of the branch node N4 selected in the previous step 10A is less than or equal an M_MAX value. If the Svalue of the examined branch node N4 is less than or equal to an M_MAX value, then the computer C4 proceeds from step 10B to execute step 9A and to serialize and store a segment ST2 derived from the branch R4 originated by the instant branch node N4 most recently selected in step 10A. If the Svalue of the examined branch node N4 of step 10B is greater than an M_MAX value, then the computer C4 proceeds on from step 10B to execute step 10C to determine if a sub-branch R6 of the branch R4 originated by the instant branch node N4 is less than or equal to the M_MAX value. If a subordinate intermediate node N6 of the most recently examined branch node N4 is found to have an Svalue less than or equal to the M_MAX value, then the computer C4 proceeds on to step 9A from step 10C to serialize and store a segment SB derived from the sub-branch R6 selected in step 10C. The software execution of the computer C4 will return to step 10D after passing from steps 10B or 10C to step 9A and after executing the process of serialization process of FIG. 9. In step 10E the computer C4 determines if there are any remaining unexamined branches R4 to analyze for immediate storage in the secondary memory C6 and prompt removal from the main memory C2. The software execution flow returns to step 7K from step 10D after each branch R4 of the R-tree R2 has been examined for expedited transfer to the secondary memory C6.

Referring now generally to the Figures and particularly to FIG. 11, FIG. 11 is an alternate variation of the process of FIG. 10 wherein serialized segments ST2 & ST4 requiring a memory size between M_MIN and M_MAX inclusively may be stored without a minimum memory size requirements. The execution of the process of FIG. 11 by the computer C4 expedites transfer of segments ST2 & ST4 of the R-tree R2 from the main memory C2 by removing any branch or sub-branch that presents (a.) a T_R less a time T value, and (b.) an Svalue no larger than an M_MAX value, e.g., 2 Mbytes of memory storage, and without regard to a minimum disc storage size requirement. In step 11C a branch R4 of a branch node N4 found to have an Svalue of no more than an M_MAX value and a T_R value less than a time T will be selected for serialization and archiving into the secondary memory C6 as per the software process of FIG. 9. In step 11B a sub-branch R6 of an intermediate node N4 found to have an Svalue of no more than an M_MAX value and, as determined in step 11C, a T_R value less than the time T_0 will be selected for serialization and archiving into the secondary memory C6 as per the software process of FIG. 9. The software execution of the computer C4 will return to step 11E after passing from step 11C to step 9A and after executing the process of serialization process of FIG. 9. The software execution flow returns from step 11E to step 7K when each branch R4 and the sub-branches R6 of the unarchived branches R4 have each been examined for transfer to the secondary memory C6.

Referring now generally to the Figures and particularly to FIG. 12, FIG. 12 is an alternate variation of the process of FIG. 10 wherein serialized segments ST2 & ST4 requiring a memory size no smaller than M_MIN n and no greater than M_MAX inclusively and without regard to a T_R value. The execution of the process of FIG. 12 by the computer C4 expedites transfer of segments ST2 & ST4 of the R-tree R2 from the main memory C2 by removing any branch or sub-branch that presents an Svalue (a.) no smaller than and M_MIN value, e.g., 256 Kbytes of memory locations, and (b.) no larger than an M_MAX value, e.g., 2 Mbytes of memory capacity, and without regard to a T_R value of the relevant nodes N2-N8. In step 12B a branch R4 of a branch node N4 found to have an Svalue both (a.) no less than an M_MIN value, and (b.) no more than an M_MAX value is selected for serialization and archiving into the secondary memory C6 as per the software process of FIG. 9. In step 12C a sub-branch R6 of an intermediate node N4 found to have an Svalue both (a.) no less than an M_MIN value, and (b.) no more than an M_MAX value is selected for serialization and archiving into the secondary memory C6 as per the software process of FIG. 9. The software execution of the computer C4 will return to step 12D after passing from steps 12B or 12C to step 9A and after executing the process of serialization process of FIG. 9. The software execution flow returns from step 12G to step 7K when each branch R4 and the remaining sub-branches R6 of the unarchived branches R4 have each been examined for transfer to the secondary memory C6.

Referring now generally to the Figures and particularly to FIG. 13, FIG. 13 is a schematic of a serialized segment SB of the R-Tree R2 of FIG. 1 as stored in a block B of contiguous memory locations of a data storage disk of the computer of FIG. 4. The header SBH and the trailer SBT contain size information plus serialization numbers that support or enable recovery of the serialized segment SB in the event of certain types and degrees of malfunction of the secondary memory C6. The serialization numbers of the header SBH and the trailer SBT further associate the serialized segment SB with the R-tree R2 and other serialized segments ST2 & ST4 derived from the R-tree R2. In addition, the size and serialization numbers of the header SBH and the trailer SBT further identify and distinguish the serialized segment SB form other serialized segments ST2 & ST4 derived from the R-tree R2.

The serialized segment SB further includes nodes R2-R8 and events E, with the pointers P1-P6 translated from memory addresses of the main memory R4 to offsets that directly associate a node R2-R8 with immediately subordinate nodes R4-R8 and events E with offset counts that specify the location of the subordinate nodes N4-N8 and events E stored within the same serialized segment SB.

The above description is intended to be illustrative, and not restrictive. The examples given should only be interpreted as illustrations of some of the preferred embodiments of the invention, and the full scope of the invention should be determined by the appended claims and their legal equivalents. Those skilled in the art will appreciate that various adaptations and modifications of the just-described preferred embodiments can be configured without departing from the scope and spirit of the invention. The scope of the invention as disclosed and claimed should, therefore, be determined with reference to the knowledge of one skilled in the art and in light of the disclosures presented above.

We claim:

1. In a computer system having a main memory and a secondary memory, a method for processing and storing event data, each event data having a time value, the method comprising:
a. storing a plurality of event data into main memory;
b. assigning up to N event data to one of a plurality of leaf nodes in a tree structure, each leaf node address stored in either a root node or a branch node, each branch node storing the most recent time value T_R and the most aged value T_A of time values of associated event data;
c. selecting a time T_0; and
d. transferring each branch node and associated nodes and event data having a T_R later than T_0 to the secondary memory.

2. The method of claim 1, wherein each branch node and associated nodes and event data define a branch, and each branch is examined for having a T_R less than T_0 in order from largest in memory size to smallest in memory size.

3. The method of claim 2, wherein each branch having a memory size greater than M and a T_R later than T_0 is transferred to the secondary memory.

4. The method of claim 1, wherein the nodes and event data are serialized after selection for transfer to the secondary memory and transferred as a serialized segment.

5. The method of claim 2, wherein the nodes are organized into an R-tree and each event data comprises a time value and at least (additional) one dimensional value.

6. In a computer system having a main memory and a secondary memory, a method for generating and storing an R-tree, the method comprising:
a. Storing a plurality of events as received by the computer system into R-tree nodes in a main memory, each event and each node having at least two bounding dimensions;
b. Selecting a sub-branch of the R-tree for transfer onto the secondary medium on the basis of a memory size M of the sub-branch; and
c. Serializing a selected sub-branch; and
d. Storing the serialized sub-branch in the secondary memory in a memory serialized segment.

7. The method of claim 6, wherein the sub-branch is selected when the most recent event of the sub-branch less recent than a time T.

8. The method of claim 6, wherein the sub-branch is selected when the memory size is less than a size M.

9. The method of claim 6, wherein time is a dimension.

10. The method of claim 6, wherein at least one dimension is selected from the group including:
a. time;
b. eventtype;
c. source IP;
d. destination IP;
e. destination port; and
f. sourcing switch/physical port; and
g. event priority.

11. The method of claim 6, wherein the secondary memory is communicatively coupled to the main memory via a computer network.

12. The method of claim 6, wherein the secondary memory is a peripheral memory.

13. The method of claim 12, wherein the peripheral memory is a magnetic disk.

14. The method of claim 12, wherein the peripheral memory is an optical disk

15. The method of claim 6, wherein the computer system further comprises a cache memory, and at least one serialized sub-branch is temporarily stored in the cache memory prior to transfer of the serialized sub-branch to the secondary memory.

16. A system for generating and storing an R-tree, the system comprising:
a. A main memory for storing a plurality of events as received by the system into R-tree nodes, each event and each node having at least two bounding dimensions;
b. Means for selecting a sub-branch of the R-tree for transfer onto the secondary medium on the basis of a memory size M of the sub-branch; and
c. Means for serializing a selected sub-branch; and
d. A secondary memory for storing the serialized sub-branch within a memory serialized segment.

17. The system of claim 16, wherein the sub-branch is selected when the most recent event of the sub-branch less recent than a time T_0.

18. The system of claim 16, wherein the sub-branch is selected when the memory size is less than a size M.

19. The system of claim 16, wherein time is a bounding dimension.

20. The system of claim 16, wherein at least one bounding dimension is selected from the group including:
a. time;
b. event type;
c. source IP;
d. destination IP;
e. destination port; and
f. sourcing switch/physical port; and
g. event priority.

21. The method of claim 16, wherein the secondary memory is communicatively coupled to the main memory via a computer network.

22. The system of claim 16, wherein the secondary memory is a peripheral memory.

23. The system of claim 22, wherein the peripheral memory comprises a magnetic data storage disk.

24. The system of claim 22, wherein the peripheral memory comprises an optical data storage disk.

25. The system of claim 16, wherein the system further comprises a cache memory, and at least one serialized sub-branch is temporarily stored in the cache memory prior to transfer of the serialized sub-branch to the secondary memory.

28. In an information technology system, the information technology system for storing a plurality of event data, each event data having a time dimensional value T_R and at least one additional dimensional value, the informational technology system having a main memory and a secondary memory, a method for storing data, comprising:
a. providing a data tree, the data tree comprising a plurality of event data clusters, wherein in each cluster has a maximum of N event data;
b. providing a new event data;
c. assigning the new event data to the closest related cluster having less than N assigned event data;
d. selecting a time T; and
e. transferring each branch node and associated nodes and event data having a T_R later than T_0 to the secondary memory.
